(19) United States
(12) Patent Application Publication
(10) Pub. No.: US 2007/0223822 A1
(43) Pub. Date: Sep. 27, 2007

(54) Data compression method used in downhole applications

(75) Inventor: Samuel Mark Haugland, Houston, TX (US)

Correspondence Address: W-H ENERGY SERVICES, INC., 2000 W. Sam Houston Pkwy. S, SUITE 500, HOUSTON, TX, 77042, US

(73) Assignee: PathFinder Energy Services, Inc., Houston, TX (US)

(21) Appl. No.: 11/384,969

(22) Filed: Mar. 20, 2006

(51) Int. Cl. G06K 9/36

(52) U.S. Cl. 382/232

(57) ABSTRACT

A method for compressing borehole image data is disclosed. In one exemplary embodiment, the method includes acquiring image data downhole, selecting a block of the image data to compress, applying at least one filter to the block, selecting a subset of pixels from the block, and quantizing each of the subset of pixels. Exemplary methods in accordance with this invention may advantageously provide for sufficient data compression to enable conventional telemetry techniques to be utilized for transmitting borehole images to the surface in substantially real time. Moreover, exemplary methods in accordance with this invention reduce data latency and the susceptibility to telemetry errors as compared to the prior art.

### FIELD OF THE INVENTION

The present invention relates generally to data communication between a downhole tool deployed in a subterranean borehole and surface instrumentation. More particularly, this invention relates to downhole techniques for compressing logging while drilling image data prior to transmission to the surface.

### BACKGROUND OF THE INVENTION

Logging techniques for determining numerous borehole and formation characteristics are well known in oil drilling and production applications. Such logging techniques include, for example, natural gamma ray, spectral density, neutron density, inductive and galvanic resistivity, acoustic velocity, acoustic caliper, downhole pressure, and the like. In conventional wireline logging applications, a probe having various sensors is lowered into a borehole after the drill string and bottom hole assembly (BHA) have been removed. Various parameters of the borehole and formation are measured and correlated with the longitudinal position of the probe as it is pulled uphole. More recently, the development of logging while drilling (LWD) applications has enabled the measurement of such borehole and formation parameters to be conducted during the drilling process. The measurement of borehole and formation properties during drilling has been shown to improve the timeliness and quality of the measurement data and to often increase the efficiency of drilling operations.

LWD tools are often used to measure physical properties of the formations through which a borehole traverses. Formations having recoverable hydrocarbons typically include certain well-known physical properties, for example, resistivity, porosity (density), and acoustic velocity values in a certain range. Such LWD measurements may be used, for example, in making steering decisions for subsequent drilling of the borehole. For example, an essentially horizontal section of a borehole may be routed through a thin oil bearing layer (sometimes referred to in the art as a payzone). Due to the dips and faults that may occur in the various layers that make up the strata, the drill bit may sporadically exit the oil-bearing layer and enter nonproductive zones during drilling. In attempting to steer the drill bit back into the oil-bearing layer (or to prevent the drill bit from exiting the oil-bearing layer), an operator typically needs to know in which direction to turn the drill bit (e.g., up, down, left, or right). In order to make correct steering decisions, information about the strata, such as the dip and strike angles of the boundaries of the oil-bearing layer is generally required. Such information may possibly be obtained from azimuthally sensitive measurements of the formation properties and, in particular, from images derived from such azimuthally sensitive measurements.

Downhole imaging tools are conventional in wireline applications. Such wireline tools typically create images by sending large quantities of azimuthally sensitive logging data uphole via a high-speed data link (e.g., a cable). Further, such wireline tools are typically stabilized and centralized in the borehole and include multiple (often times one hundred or more) sensors (e.g., resistivity electrodes) extending outward from the tool into contact (or near contact) with the borehole wall. It will be appreciated by those of ordinary skill in the art that such wireline arrangements are not suitable for typical LWD applications. For example, communication bandwidth with the surface is typically insufficient during LWD operations to carry large amounts of image-related data (e.g., via known mud pulse telemetry or other conventional techniques).

Several LWD imaging tools and methods have been disclosed in the prior art. Most make use of the rotation (turning) of the BHA (and therefore the LWD sensors) during drilling of the borehole. For example, U.S. Pat. No. 5,473,158 to Holenka et al. discloses a method in which sensor data (e.g., neutron count rate) is grouped by quadrant about the circumference of the borehole. Likewise, U.S. Pat. No. 6,307,199 to Edwards et al., U.S. Pat. No. 6,584,837 to Kurkoski, and U.S. Pat. No. 6,619,395 to Spros disclose similar binning methods. In an alternative approach, U.S. application Ser. No. 10/827,324, which is commonly assigned with the present invention, discloses a method whereby azimuthally sensitive sensor data are convolved with a predetermined window function. Such an approach tends to advantageously reduce image noise as compared to the above described binning techniques.

Logging data is conventionally transmitted to the surface via mud pulse telemetry techniques. Such techniques are typically limited to data transmission rates (bandwidth) on the order of only a few bits per second. Since LWD imaging sensors typically generate data at much higher rates than is possible to transmit to the surface, borehole images are often processed from data stored in memory only after the tools have been removed from the wellbore. Significant data compression is required to transmit images to the surface during drilling. While the above described binning and windowing techniques do provide for significant data reduction, still further data compression is necessary in order to transmit images to the surface in a timely fashion (e.g., such that the borehole images may be utilized in steering decisions).

U.S. Pat. No. 6,405,136 to Li et al. discloses a method for compressing borehole image data, which includes generating a two-dimensional Fourier Transform of a frame of data, transmitting a quantized representation of some of the Fourier coefficients to the surface, and applying a forward Fourier Transform to the coefficients to recover an approximate image at the surface. One drawback with the Li et al approach is that each pixel of the recovered image depends on all of the transmitted Fourier coefficients. If any of the transmitted Fourier coefficients are in error, the entire frame tends to be corrupted. Various conventional techniques may be utilized to minimize the effect of telemetry errors, however, such encoding schemes require transmitting additional data, which limits the amount of compression that may be achieved. Another drawback with the Li et al approach is that relatively large data frames are required in order to get sufficient compression, which thereby increases data latency (the time delay between when the data is generated downhole and received at the surface).

Therefore there exists a need for an improved data compression method, and in particular a data compression method suitable for sufficiently compressing LWD image data so that it may be transmitted to the surface via conventional telemetry techniques.

### SUMMARY OF THE INVENTION

The present invention addresses one or more of the above-described drawbacks of prior art data compression and communication techniques. Aspects of this invention include a method for compressing data acquired during the drilling of a subterranean borehole (e.g., LWD and/or MWD data). While the invention is not limited in this regard, exemplary embodiments of this invention may be advantageously utilized to compress borehole image data. In such exemplary embodiments, LWD data may be acquired as function of both time and sensor tool face. Raw image data is typically filtered by the application of at least one (and preferably two) one-dimensional numerical filter, although the invention is not limited in regards to the number and type of filter (such as a two-dimensional filter) applied. The filtered data may then be resampled and quantized (re-digitized) prior to transmission to the surface. In one alternative embodiment, the data is critically sampled and only the pixels corresponding to the critical samples are filtered.

Exemplary embodiments of the present invention may advantageously provide several technical advantages. For example, exemplary methods according to this invention typically provide for sufficient data compression to enable conventional telemetry techniques to be utilized for transmitting borehole images to the surface. Moreover, methods in accordance with this invention reduce the susceptibility to telemetry errors as compared to the prior art. As described in more detail below, the occurrence of a telemetry error often effects only a single pixel in the image. Methods in accordance with this invention also advantageously tend to reduce data latency as compared to the prior art since smaller data blocks may be telemetered to the surface.

In one aspect the present invention includes a method for compressing borehole image data. The method includes acquiring image data downhole. The image data includes discrete traces associated with corresponding discrete times, each of the discrete traces including a plurality of borehole parameter values at a corresponding plurality of discrete tool face angles such that the image data includes a two-dimensional array of pixels. The method further includes selecting a block of the image data to compress, the block including at least one of the discrete traces and applying at least one filter to the block. The method still further includes selecting a subset of pixels from the block, the subset of pixels including at least two of the plurality of discrete tool face angles and at least one of the plurality of discrete times and quantizing each of the subset of pixels.

In another aspect, this invention includes a method for compressing borehole image data. The method includes acquiring image data downhole, the image data including a two-dimensional array of pixels, each pixel including a borehole parameter value at a corresponding discrete time and a corresponding discrete tool face angle. The method further includes applying a filter to selected ones of the array of pixels, thereby generating filtered pixels and quantizing the filtered pixels.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts one exemplary LWD tool deployed in a borehole and suitable for use in accordance with aspects of this invention.

FIG. 2 depicts an exemplary, hypothetical borehole image including a substantially continuous stream of sensor data as a function of sensor tool face and time.

FIG. 3 depicts an exemplary borehole image pixilated via convolving the sensor data from the image shown on FIG. 2 with a window function.

FIG. 4 depicts a flowchart of one exemplary method embodiment of this invention.

FIG. 5 depicts the borehole image of FIG. 3 further compressed in accordance with exemplary method embodiments of the present invention.

FIG. 6 depicts a plot of dB versus normalized frequency for exemplary filter embodiments in accordance with this invention.

### DETAILED DESCRIPTION

Before proceeding with a discussion of the present invention, it is necessary to make clear what is meant by “azimuth” as used herein. The term azimuth has been used in the downhole drilling art in two contexts, with a somewhat different meaning in each context. In a general sense, an azimuth angle is a horizontal angle from a fixed reference position. Mariners performing celestial navigation used the term, and it is this use that apparently forms the basis for the generally understood meaning of the term azimuth. In celestial navigation, a particular celestial object is selected and then a vertical circle, with the mariner at its center, is constructed such that the circle passes through the celestial object. The angular distance from a reference point (usually magnetic north) to the point at which the vertical circle intersects the horizon is the azimuth. As a matter of practice, the azimuth angle was usually measured in the clockwise direction.

In this traditional meaning of azimuth, the reference plane is the horizontal plane tangent to the earth's surface at the point from which the celestial observation is made. In other words, the mariner's location forms the point of contact between the horizontal azimuthal reference plane and the surface of the earth. This context can be easily extended to a downhole drilling application. A borehole azimuth in the downhole drilling context is the relative bearing direction of the borehole at any particular point in a horizontal reference frame. Just as a vertical circle was drawn through the celestial object in the traditional azimuth calculation, a vertical circle may also be drawn in the downhole drilling context with the point of interest within the borehole being the center of the circle and the tangent to the borehole at the point of interest being the radius of the circle. The angular distance from the point at which this circle intersects the horizontal reference plane and the fixed reference point (e.g., magnetic north) is referred to as the borehole azimuth. And just as in the celestial navigation context, the azimuth angle is typically measured in a clockwise direction.

It is this meaning of “azimuth” that is used to define the course of a drilling path. The borehole inclination is also used in this context to define a three-dimensional bearing direction of a point of interest within the borehole. Inclination is the angular separation between a tangent to the borehole at the point of interest and vertical. The azimuth and inclination values are typically used in drilling applications to identify bearing direction at various points along the length of the borehole. A set of discrete inclination and azimuth measurements along the length of the borehole is further commonly utilized to assemble a well survey (e.g., using the minimum curvature assumption). Such a survey describes the three-dimensional location of the borehole in a subterranean formation.

A somewhat different meaning of “azimuth” is found in some borehole imaging art. In this context, the azimuthal reference plane is not necessarily horizontal (indeed, it seldom is). When a borehole image of a particular formation property is desired at a particular depth within the borehole, measurements of the property are taken at points around the circumference of the measurement tool. The azimuthal reference plane in this context is the plane centered at the center of the measurement tool and perpendicular to the longitudinal direction of the borehole at that point. This plane, therefore, is fixed by the particular orientation of the borehole at the time the relevant measurements are taken.

An azimuth in this borehole imaging context is the angular separation in the azimuthal reference plane from a reference point to the measurement point. The azimuth is typically measured in the clockwise direction, and the reference point is frequently the high side of the borehole or measurement tool, relative to the earth's gravitational field, though magnetic north may be used as a reference direction in some situations. Though this context is different, and the meaning of azimuth here is somewhat different, this use is consistent with the traditional meaning and use of the term azimuth. If the longitudinal direction of the borehole at the measurement point is equated to the vertical direction in the traditional context, then the determination of an azimuth in the borehole imaging context is essentially the same as the traditional azimuthal determination.

Another important label used in the borehole imaging context is the “tool face angle”. When a measurement tool is used to gather azimuthal imaging data, the point of the tool with the measuring sensor is identified as the “face” of the tool. The tool face angle, therefore, is defined as the angular separation from a reference point to the radial direction of the tool face. The assumption here is that data gathered by the measuring sensor will be indicative of properties of the formation along a line or path that extends radially outward from the tool face into the formation. The tool face angle is an azimuth angle, where the measurement line or direction is defined for the position of the tool sensors. In the remainder of this document, the terms azimuth and tool face angle will be used interchangeably, though the tool face angle identifier will be used predominantly.

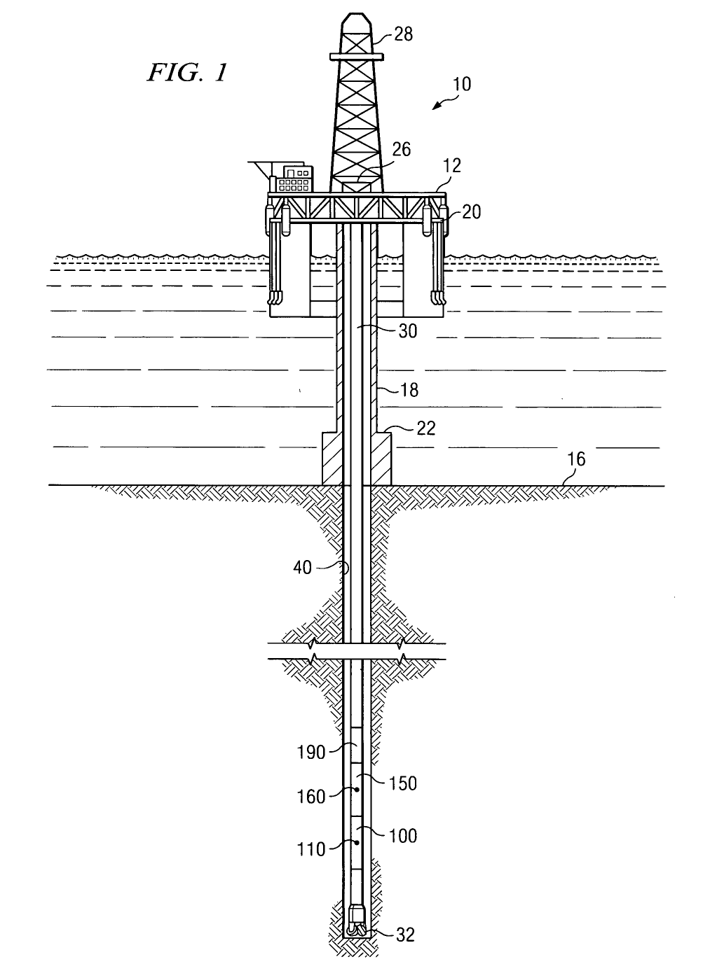

With reference now to FIG. 1, an exemplary offshore drilling assembly, generally denoted 10, suitable for employing exemplary method embodiments in accordance with the present invention is illustrated. In FIG. 1, a semisubmersible drilling platform 12 is positioned over an oil or gas formation (not shown) disposed below the sea floor 16. A subsea conduit 18 extends from deck 20 of platform 12 to a wellhead installation 22. The platform may include a derrick 26 and a hoisting apparatus 28 for raising and lowering the drill string 30, which, as shown, extends into borehole 40 and includes a bottom hole assembly (BHA) having a drill bit 32, an LWD tool 100, an imaging sub 150, and a telemetry sub 190 coupled thereto.

LWD tool 100 typically includes at least one LWD sensor 110 deployed thereon. LWD sensor 110 may include substantially any downhole logging sensor, for example, including a natural gamma ray sensor, a neutron sensor, a density sensor, a resistivity sensor, a formation pressure sensor, an annular pressure sensor, an ultrasonic sensor, an audio-frequency acoustic sensor, and the like. Imaging sub 150 includes at least one tool face sensor 160 deployed thereon. Tool face sensor 160 may include substantially any sensor that is sensitive to sensor tool face (e.g., relative to the high side of the borehole, magnetic north, etc.), such as one or more accelerometers and/or magnetometers. As described in more detail below, LWD tool 100 and imaging sub 150 may be configured to acquire borehole images of one or more borehole properties (e.g., formation resistivity). Telemetry sub 190 may include substantially any conventional telemetry system for communicating with the surface, such as a mud pulse telemetry system and may likewise employ substantially any suitable encoding scheme. Drill string 30 on FIG. 1 may further include a downhole drill motor and other logging and/or measurement while drilling tools, such as surveying tools, formation sampling tools, drill string steering tools, and the like.

It will be understood by those of ordinary skill in the art that methods in accordance with the present invention are not limited to use with a semisubmersible platform 12 as illustrated in FIG. 1. Methods in accordance with this invention are equally well suited for use with any kind of subterranean drilling operation, either offshore or onshore.

LWD tool 100 may further optionally include an energy source (not shown). For example, an LWD tool configured for azimuthal gamma measurements may include a gamma radiation source (such a device is typically referred to as a density measurement device). Likewise, LWD tools configured for azimuthal resistivity and acoustic velocity measurements may include one or more electromagnetic wave generators and acoustic transmitters, respectively. The invention is not limited, however, to the use of an energy source since the LWD sensor 110 may be utilized to measure naturally occurring formation parameters (e.g., a natural gamma ray sensor may be utilized to measure azimuthally sensitive natural gamma ray emissions).

In the exemplary embodiment shown in FIG. 1, the LWD sensor 110 and the tool face sensor 160 are deployed in separate tools. It will be appreciated that the invention is not limited in this regard. For example, LWD tool 100 may include a tool face sensor deployed therein. Tool face sensor 160 may also be deployed elsewhere in the drill string 30. Moreover, methods in accordance with the present invention are not limited to use with borehole imaging data. Exemplary embodiments of this invention may be utilized to compress substantially any downhole data (i.e., substantially any volume of data acquired from substantially any downhole sensor).

With continued reference to FIG. 1, downhole tool 100 and/or imaging sub 150 typically further includes a controller (not shown), e.g., having a programmable processor (not shown), such as a microprocessor or a microcontroller and processor-readable or computer-readable program code embodying logic. A suitable processor may be utilized, for example, to construct images (as described in more detail below) of the subterranean formation based on azimuthally sensitive sensor measurements and associated tool face and measured depth information. The processor is typically further utilized to compress the data in accordance with this invention, for example, by applying a suitable filter to the raw data. The processor may be further utilized to encode the compressed data prior to transmission to the surface. A suitable controller may also optionally include other controllable components, such as sensors (e.g., a depth sensor), data storage devices, power supplies, timers, and the like. The controller is also typically disposed to be in electronic communication with sensors 110 and 160. A suitable controller may also optionally communicate with other instruments in the drill string, such as telemetry sub 190. A typical controller may further optionally include volatile or non-volatile memory or a data storage device.

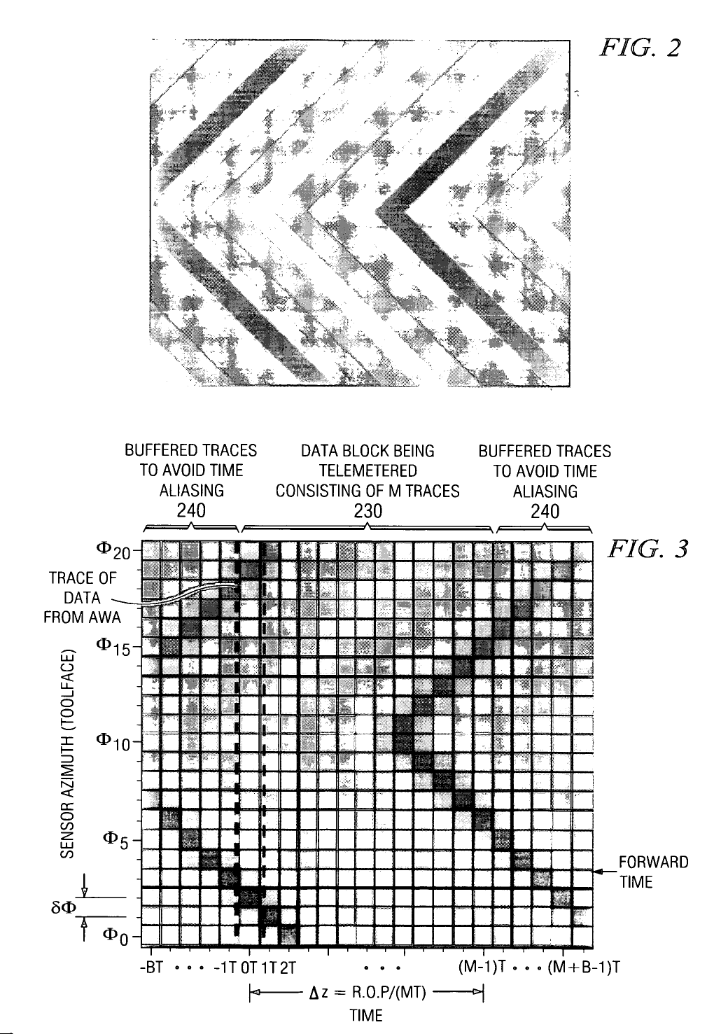

Turning now to FIGS. 2 and 3, exemplary embodiments of this invention may be advantageously utilized to compress borehole image data. In general, an image may be thought of as a two-dimensional representation of a parameter value. For the purposes of this disclosure, a borehole image may be thought of as a two-dimensional representation of a measured formation (or borehole) parameter as a function of sensor tool face and time. Time is typically correlated with a borehole depth value at the surface because such a borehole depth value is typically not accessible within the imaging sub. Such borehole images thus convey the dependence of the measured formation (or borehole) parameter on tool face and depth. It will therefore be appreciated that one purpose in forming such images of particular formation or borehole parameters (e.g., formation resistivity, dielectric constant, density, acoustic velocity, etc.) is to determine the actual azimuthal dependence of such parameters as a function of the borehole depth. Exemplary embodiments of this invention may advantageously enable timely transmission of such dependencies to the surface.

In a typical borehole imaging application, an LWD tool may include, for example, one or more sensors deployed on an outer surface of the tool that are disposed to make substantially continuous measurements of a formation property adjacent the sensor (e.g., sensor 110 on LWD tool 100 shown on FIG. 1). It will be appreciated that as the tool rotates in the borehole, the tool face of the sensor in the borehole changes with time. In one exemplary embodiment, a continuous LWD sensor response may be averaged at some predetermined sampling interval (e.g., 10 milliseconds). The duration of each sampling interval is preferably significantly less than the period of the tool rotation in the borehole (e.g., the sampling interval may be about 10 milliseconds, as stated above, while the rotational period of the tool may be about 0.5 seconds). Meanwhile, a tool face sensor (e.g., sensor 160 shown on FIG. 1) continuously measures the tool face of the LWD sensor as it rotates in the borehole. The averaged LWD sensor response in each of the sampling intervals may then be tagged with a corresponding tool face and time and saved to memory. Such correlated data may then be utilized to construct an image. Were all of the correlated sensor data used, the resultant image might resemble that shown on FIG. 2 (e.g., assuming the LWD sensor has sufficient signal to noise ratio). Such an image would include an essentially continuous representation of the borehole parameter (shown in gray scale) as a function of tool face (on the y-axis) and time (on the x-axis). Of course, storing and transmitting such images is not practical due to downhole memory and communication bandwidth constraints. In addition, it may not be possible to gather a statistically significant amount of data within each sample interval.

Various techniques are known in the prior art to reduce the memory requirement and increase the statistical significance of borehole image data, including the “binning” and “windowing” techniques described above in the Background Section. Known binning techniques group (i.e., average) the data into a number of tool face and time bins. For example, sensor data may be averaged into 16 discrete tool face bins at 10 second intervals. As described in more detail below, in windowing techniques sensor data is convolved with a predetermined window function to reduce image noise. Both binning and windowing techniques essentially pixilate the borehole image as shown on FIG. 3, such that the measured borehole parameter (e.g., the logging data) is represented at discrete tool face angles and times (i.e., at tool face angles Φ₀, Φ₁, Φ₂, etc. and times 0 T, 1 T, 2 T, etc.).

One exemplary windowing technique is now described in more detail. The LWD sensor response at each sampling interval (e.g., 10 milliseconds) may be convolved with a predetermined window function. The convolution can be computed with a running sum. Each term in such a running sum may be represented, for example, as follows:

$$\frac{1}{2 π} f ( {γ}_{i} ) W ( {Φ}_{j} - {γ}_{i} ) , j = 0 , … , N - 1 \qquad Equation 1$$

where ƒ(γᵢ) represents the correlated sensor measurement and tool face γᵢ values at each sampling interval i and W(Φⱼ−γᵢ) represents the value of the predetermined window function centered on discrete predetermined azimuthal positions, Φⱼ.

Sensor data for determining the azimuthal dependence of the measured formation parameter at a particular well depth is typically gathered and grouped during a predetermined time period. The predetermined time period is typically significantly longer than both the above described rapid sampling time and the rotational period of the tool (e.g., the time period may be 1000 times longer than the rapid sampling time and 20 times longer than the rotational period of the tool). Summing the contributions to Equation 1 from P such data packets yields:

$${f}_{j} = \frac{1}{2 π {S}_{j}} {\sum }_{i = 1}^{P} f ( {γ}_{i} ) W ( {Φ}_{j} - {γ}_{i} ) \\ {S}_{j} = {\sum }_{i = 1}^{P} W ( {Φ}_{j} - {γ}_{i} ) , \\ j = 0 , … , N - 1 \qquad Equations 2$$

where ƒⱼ represents the convolved sensor data stored at each discrete azimuthal position j. The sum is normalized by the factor 1/Sⱼ so that the value of ƒⱼ is independent of P in the large P limit.

In the exemplary embodiment described, ƒⱼ, as given in Equation 2, represents the convolved sensor data for a single well depth (i.e., ƒⱼ represents a single “trace” of sensor data). To form a two-dimensional image, it will be understood that multiple traces are required. Such traces are typically acquired during consecutive time periods using the procedure described above to acquire each trace. For example, in one exemplary embodiment, sensor data may be acquired substantially continuously during at least a portion of a drilling operation. Sensor data may be grouped by time (e.g., in 10 second intervals) with each group indicative of a single trace (i.e., a single well depth). In one exemplary embodiment, each data packet may be acquired in about 10 milliseconds. Such data packets may be grouped at about 10 second intervals resulting in about 1000 data packets per group. It will be appreciated that this invention is not limited to any particular rapid sampling and/or time periods. Nor is this invention limited to the use of a windowing algorithm. For example, this invention could be applied directly to individual data packets. This would be tantamount to using a windowing algorithm but with P=1.

Although the exemplary image acquisition technique described above involves rotating a sensor in the borehole, it will be understood that the invention is not limited in this regard either. Images may also be obtained, for example, in sliding mode by utilizing downhole tools having multiple sensors distributed about the periphery of the tool.

The above described binning and windowing techniques are known to provide significant data reduction such that borehole images may be suitably stored in downhole memory with the stored data typically representing statistically significant quantities. However, still further compression (reduction) is typically necessary in order to transmit images to the surface in a timely fashion (in substantially real time) using conventional telemetry techniques such as mud pulse telemetry. Exemplary embodiments of the present invention are intended to provide for such further reduction and thus enable images to be transmitted to the surface in substantially real time.

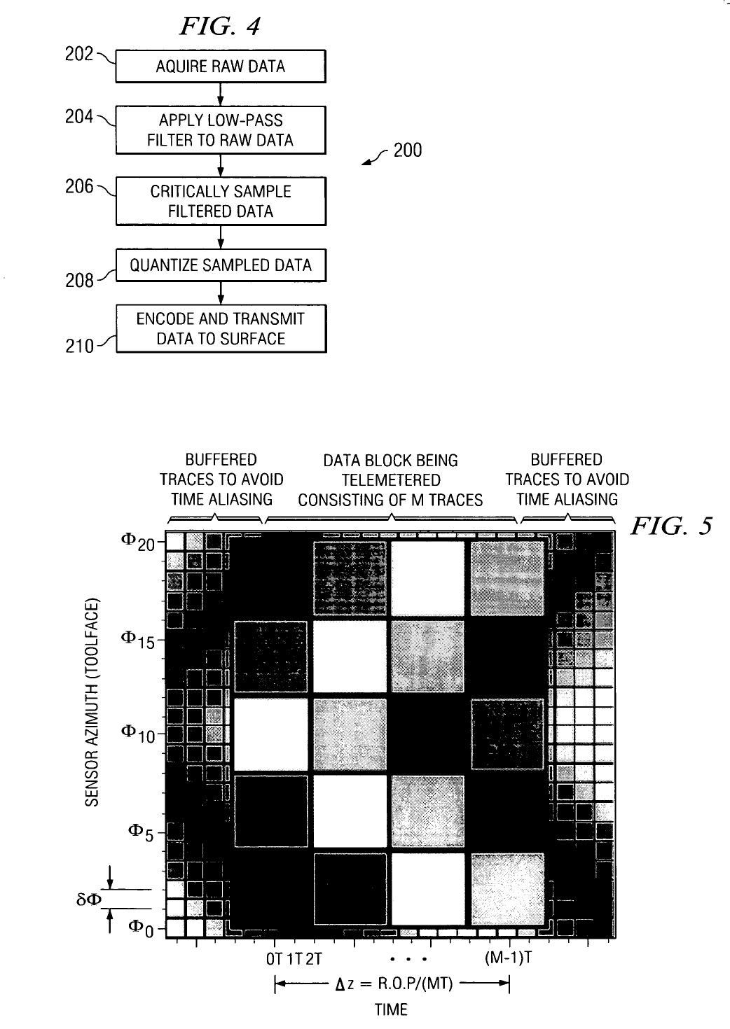

Turning now to FIG. 4, one exemplary embodiment of a data compression method 200 in accordance with the present invention is illustrated. Raw data are acquired at a controller (not shown) at 202. Such raw data may include, for example, a plurality of traces acquired via conventional binning or windowing techniques and may therefore essentially constitute image data such as that represented graphically on FIG. 3. A numerical filter is applied to the raw data at 204. As described in more detail below, borehole image data is typically filtered in two dimensions (tool face and time). The filtered data may then be critically sampled, for example, at predetermined tool face and time values at 206. It will be understood to those of ordinary skill in the art that the filtering and sampling steps shown at 204 and 206 may alternatively be combined into a single step, for example, by filtering the raw data only at preselected tool face and time values. The critical samples selected at 206 are typically quantized (i.e., re-digitized) at 208 and may be further encoded and transmitted to the surface at 210, using substantially any known telemetry techniques used in the downhole arts.

Execution of exemplary method embodiments in accordance with the present invention (e.g., as described above) further compresses borehole image data and typically results in a compressed image such as that illustrated on FIG. 5. It will be appreciated by those of ordinary skill in the art, that while the spatial resolution of the compressed image is degraded as compared to the original image, useful information may nevertheless be derived from it. First, for any particular trace (which may be correlated with a particular well depth) the azimuthal dependence of the measured borehole parameter may be evaluated. For example, for trace 0 T in FIG. 5, the borehole parameter has a high value on one side of the borehole (at Φ₁₀) and a low value on the other side of the borehole (at Φ₂ and Φ₁₈). Furthermore, the “pattern” of the original image (e.g., as shown on FIG. 3) may be retained even when the image is highly compressed (e.g., as shown on FIG. 5). The hypothetical image data shown on FIGS. 3 and 5 is representative of a bedding interface intersecting a borehole. As is known to those of ordinary skill in the subterranean drilling arts, such images may be utilized to evaluate the orientation of the bedding interface with respect to the borehole (and therefore with respect to the surface of the earth as well). Retention of the original pattern in the compressed image may advantageously enable bedding interface orientation (among other factors) to be evaluated in substantially real time during drilling.

With continued reference to FIG. 4 and further reference to FIG. 3, exemplary method embodiments of this invention are discussed in more detail. As stated above, the data shown in FIG. 3 are representative of a gray-scale image that may be generated by applying known binning or windowing algorithms (such as the windowing algorithm described above with respect to Equations 1 and 2) to logging data gathered in a borehole. FIG. 3 illustrates an exemplary data block 230 to be compressed in accordance with the present invention for substantially real-time transmission to the surface. Exemplary data block 230 includes M=13 traces (0 T, 1 T, . . . , (M−1)T), each of which includes parameter values in N=21 azimuthal windows (Φ₀, Φ₁, . . . , Φ₂₀). As shown on FIG. 3, the oldest traces are to the right and the most recent traces are to the left. In the example shown on FIGS. 3 and 5, data block 230 is compressed from an image including 13 traces and 21 azimuthal windows (as shown on FIG. 3) to a compressed image including 4 traces and 5 azimuthal windows (as shown on FIG. 5). The heavy tick marks on the axes indicate the predetermined tool face and time values that have been selected for sampling. In the exemplary embodiment shown, data block 230 is sampled at tool faces Φ₂, Φ₆, Φ₁₀, Φ₁₄, and Φ₁₈ and times 0 T, 4 T, 8 T, and 12 T.

With continued reference to FIG. 3, data block 230 may be advantageously padded with a plurality of buffer traces 240 (e.g., from 3 to about 8 traces before and after the data block 230). The buffer traces 240 are intended to provide continuity of the data block 230 in time. Since the data block 230 is not typically periodic in time, the buffer traces reduce aliasing effects caused by filtering. In one advantageous embodiment each data block is padded with enough buffer traces to cover half the length of the numerical filter (as described in more detail below). The exemplary image data shown on FIG. 3 includes B=5 buffer traces before and after data block 230.

Data block 230 and buffer traces 240 may be denoted by a two-dimensional indexing scheme such that the data in the data block 230 may be represented mathematically, for example, as follows:
ƒⱼₖ,j=0, . . . ,N−1;k=0, . . . ,M−1 Equation 3

The buffer data on the left (corresponding to traces generated after data block 230 and which may be in the next data block to be transmitted to the surface) may be represented mathematically, for example, as follows:
ƒⱼₖ,j=0, . . . ,N−1;k=−B, . . . ,−1 Equation 4

The buffer data on the right (corresponding to traces generated before data block 230 and which may have been in the previously transmitted data block) may be represented mathematically, for example, as follows:
ƒⱼₖ,j=0, . . . ,N−1;k=M, . . . , M+B−1. Equation 5

where ƒⱼₖ represents the measured parameter value at pixels j and k in data block 230 or buffer 240, j represents sequential tool face positions Φ₀, Φ₁, Φ₂, etc. and k represents sequential time intervals 0 T, 1 T, 2 T, etc.

With continued reference to FIGS. 3 and 4, one or more numerical (digital) filters may be applied to data block 230 at 204. Exemplary filters may be represented mathematically by a series of filter coefficients, for example, as follows:
hₚ,p=−m, . . . ,+m Equation 6
g_{q},q=−n, . . . ,+n Equation 7

where filter hₚ includes 2m+1 coefficients and filter g_{q} includes 2n+1 coefficients. It will be appreciated that filters hₚ and g_{q} may include substantially any suitable filter, for example, including low-pass and band-pass numerical filters.

In one exemplary filtering operation, filter hₚ may be applied to image data ƒⱼₖ in the j-direction (the vertical direction in FIG. 3, i.e., to each trace of the data) while filter g_{q} may be applied to the data in the k-direction (the horizontal direction in FIG. 3). The result of the filtering operation in the j-direction may be expressed mathematically, for example, as follows:

$${f}_{jk}^{′} = {\sum }_{p = - m}^{+ m} {h}_{p} {f}_{{( j - p )}^{′} , k} , j = 0 , … , N ; \\ k = 0 , … , M - 1 \qquad Equation 8$$

where ƒ′ⱼₖ represents the image data ƒⱼₖ filtered in the j-direction. The result of a subsequent filtering operation in the k-direction may be expressed mathematically, for example, as follows:

$$\begin{matrix}{f}_{jk}^{″} = {\sum }_{q = - n}^{+ n} {g}_{q} {f}_{j , ( k - q ) , k}^{′} , j = 0 , … , N ; \\ k = 0 , … , M - 1 & \end{matrix} \qquad Equation 9$$

where ƒ″ⱼₖ represents the filtered data ƒ′ⱼₖ further filtered in the k-direction (i.e., the image data ƒⱼₖ filtered in both the j and k directions). With reference to Equation 8, (j−p)′=j−p+βN since the image data ƒⱼₖ is periodic in the j-direction (i.e., in tool face). The integer β may be positive, negative, or zero and is selected so that 0≦(j−p)′<N. As stated above, since the image data ƒⱼₖ is not generally periodic in the k-direction (i.e., in time), buffer traces 240 may be advantageously utilized to minimize aliasing effects. The use of such buffer traces tends to overcome one of the drawbacks of prior art compression algorithms, which implicitly assume that the image data is periodic in time.

Equations 8 and 9 describe a sequential filtering operation in which image data ƒⱼₖ is filtered first in the j-direction and then in the k-direction. It may be advantageous in certain applications to apply the j-direction filter to individual traces as they are received at the controller (during acquisition of the logging data). The k-direction filter may then be applied after all the traces in a given block have been received. In such an exemplary embodiment it is advantageously only necessary to retain (for real-time image compression purposes) the selected critical samples in memory (e.g., from rows j=2, 6, 10, 14, and 18 in the exemplary embodiment shown on FIG. 3). However, it will be understood that the invention is not limited in regard to the order of various filtering operations. In general, filtering in accordance with the present invention may be performed in either order or simultaneously. Moreover, in some applications it may be advantageous to filter image data ƒⱼₖ in one or more diagonal directions, for example, via two-dimensional filters.

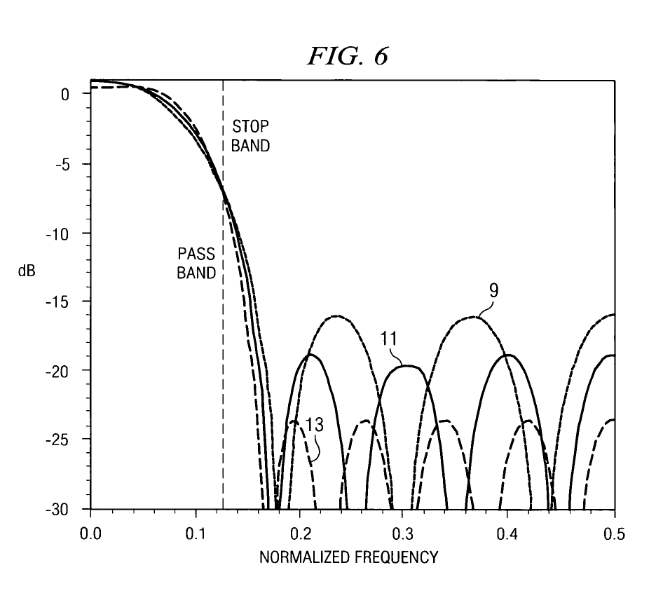

While the invention is not limited in this regard, in certain exemplary embodiments low-pass filters may be advantageously utilized. FIG. 6 illustrates the normalized frequency response of three exemplary low-pass filters. The intent of such a low pass filter is to remove high frequency components from the raw data (e.g., the binned or windowed data as described above) and thereby reduce (compress) the information content of the image. FIG. 6 shows the filter response in dB versus normalized frequency for three exemplary anti-aliasing, low-pass filters, having respective filter lengths of 9, 11, and 13 (i.e., m=n=4, 5, and 6 in Equations 6 and 7). As shown, the exemplary filters utilized in FIG. 6 have a normalized cut-off frequency of about 0.125, with frequency components above the cut-off frequency being suppressed by at least 15 dB (or more as the filter length increases from 9 to 13). Such exemplary low-pass filters are typically suitable for compressing the image by about 94 percent (i.e., removing three out of four pixels in each dimension such that the compressed image includes one-sixteenth of the original information content). One exemplary numerical filter in which m=n=5 includes the following filter coefficients:
{−0.050008, 0.022891, 0.075216, 0.142505, 0.198937, 0.220917, 0.198937, 0.142505, 0.075216, 0.022891, and −0.050008}.

It will be understood by those of ordinary skill in the art that alternative low-pass filters may be utilized if more or less data compression is desired. For example, in an application in which it is desirable to remove seven out of eight pixels in each dimension (to achieve 98 percent compression), the Nyquist Sampling Theorem states that filters having a normalized cut-off frequency of about 0.06 or less may be utilized. Alternatively, in an application in which it is desirable to remove only every other pixel (one out of two) in each dimension (to achieve 75 percent compression), the Nyquist Sampling Theorem states that filters having a normalized cut-off frequency of about 0.25 or less may be utilized. Of course, the invention is not limited in these regards. For example, a band pass filter could be used to advantageously further eliminate the low-frequency part of the image data that doesn't correspond to geometrical features to be resolved by the image. The effective bandwidth of the data would then be further reduced, and less telemetry bandwidth would be needed to transmit it.

It is typically advantageous to quantize (i.e., redigitize) the critically sampled data to reduce the information content of each pixel and thereby still further reduce the information content of the image. Such quantization is represented by the shade assignments in FIG. 5. The data are quantized according to preselected quantization parameters (which are described in more detail below) in order to achieve a selected compression ratio. For example only, in one exemplary embodiment, each critically sampled pixel of filtered data (which is typically in floating point format) may be digitized to a particular number of bits (e.g., four which would enable 16 possible parameter values). Alternatively, each critically sampled pixel of filtered data may be rounded (e.g., from floating point format) to an integer quantity. It will be appreciated that substantially any suitable digitizing algorithms and/or parameters may be utilized. The invention is expressly not limited in this regard.

In some applications the measured parameter values may be substantially symmetric (even) about a particular tool face value. This is illustrated schematically in FIGS. 3 and 5 in which the parameter values are symmetric about tool face Φ₁₀. In such instances it is may be advantageous to transmit only half of the image data (which is referred to herein as the even component of the data). In one exemplary embodiment in accordance with this invention, each trace of raw data (e.g., as shown on FIG. 3) is processed to determine the tool face about which the trace is “most even”. An entire data block may be considered even, for example, when each trace in the block is even about a common (or nearly common) tool face. For such even data blocks, a quantized version of an even component of the data block may be transmitted to the surface along with the tool face value about which the data block is even (symmetric).

The above described approach for determining the even component of a data block may be expressed mathematically as follows. As described above ƒⱼₖ denotes a pixel of data at tool face j and trace k. For example ƒ₂₂ represents the parameter value at pixel Φ₂, 2 T shown on FIG. 3. The tool face about which a particular trace k is most even may be determined, for example, by evaluated the following sum to determine the tool face j at which it is maximized.

$${\sum }_{p = 0}^{N - 1} {f}_{( p - j ) k} {f}_{( j - p ) k} , j = 0 , … , N - 1 \qquad Equation 10$$

where the periodicity of ƒ_{(j±N)k}=ƒⱼₖ is used to evaluate Equation 10 when the index is outside the range [0, N−1]. The tool face j about which Equation 10 is maximized represents the tool face about which the trace k is “most even” (i.e., the tool face at which the energy in the odd component of the trace is minimized). This “most even” tool face may be denoted jₑ. If a common value (or nearly common value) for jₑ is identified over an entire data block, then the data block may be taken to be even about jₑ and the even component of the data block, ƒⱼₖ^{e}, may be expressed mathematically, for example, as follows:

$${f}_{jk}^{e} = \frac{{f}_{( j - {j}_{e} ) k} + {f}_{( {j}_{e} - j ) k}}{2} , \begin{matrix}j = 0 , … , ( N - 1 ) / 2 \\ k = 0 , … , M - 1\end{matrix} \qquad Equation 11$$

For the raw data shown in FIG. 3, the even component would include only 11 discrete tool face values (Φ₀, . . . , Φ₁₀). The even component of the compressed data shown on FIG. 5 includes only three discrete tool face values. It will be understood that for even data blocks, transmission of ƒⱼₖ^{e} and jₑ tends to advantageously save transmission time (or enable higher resolution images) as compared to transmission of the entire data block.

A quality indicator, Q, which indicates the degree of evenness of the data block, may also be computed, for example, as follows:

$$Q = \sqrt{\frac{1}{M} {\sum }_{k = 0}^{M - 1} {( \frac{{\sum }_{p = 0}^{N - 1} {f}_{( p - {j}_{e} ) k} {f}_{( {j}_{e} - p ) k}}{{\sum }_{p = 0}^{N - 1} {f}_{pk}^{2}} )}^{2}} \qquad Equation 12$$

where Q is equal to unity for a data block that is perfectly even about jₑ. Such a quality indicator may be utilized to determine whether or not a data block is suitably even (i.e., having a Q greater than some predetermined threshold) to telemeter only the even component of the data ƒⱼₖ^{e} to the surface. Of course, the quality indicator may also be transmitted to the surface with a data block.

It will be appreciated that computer processing power may be saved by computing the even component of the critically sampled, filtered data rather than the raw data (e.g., that shown on FIG. 5 rather than that shown on FIG. 3). The invention is not limited in this regard. Moreover, it will also be appreciated that the present invention does not require the even component of a data block to be determined. Determining and transmitting an even component of a data block is merely one optional aspect of this invention.

It will be appreciated that prior to executing data compression algorithms in accordance with this invention, it is typically necessary to input various compression parameters, including, for example, the data block type, quantization parameters, and spatial sampling parameters. Such parameters may be programmed at the surface or transmitted downhole during drilling (e.g., via selecting various menu items from preselected parameter options programmed into the firmware). It is generally desirable to allow such compression parameters to be changed during a drilling operation. For example, during a geosteering operation, in which the borehole is being navigated along a thin, oil-bearing layer, it generally desirable to receive LWD data as rapidly as possible. Thus, in such applications it may be desirable to transmit low-resolution images (which are typically suitable for steering decisions) to the surface. At another time, the formation may include faults and/or fractures necessitating higher resolution images (e.g., to make an informed decision about mud density and composition).

In one exemplary embodiment, three types of data blocks are utilized, although the invention is expressly not limited in this regard, (i) full range blocks, (ii) zero mean blocks, and (iii) normalized blocks. Full range blocks include the raw data “as is” without any scaling factors or data offsets being applied. In such blocks, the range of values on the image is directly representative of the actual values of the measured parameter (e.g., formation density or resistivity). Full range blocks, while advantageously including a full range of data values, typically require a greater number of bits and therefore increased transmission time. Zero mean blocks include raw data in which the mean value has been subtracted from the image. In many cases a well resolved image may be transmitted using less bits than with a full range data block. Normalized data blocks include zero mean data that have been renormalized so that the maximum absolute value of any point in the data block is unity. Normalized data blocks tend to advantageously improve image resolution where there is little deviation from the mean value. The artisan of ordinary skill will readily recognize that any number of additional block types may also be utilized.

Exemplary quantization parameters typically include range, resolution, and linear/log. The range parameter typically depends on the block type. For full range blocks, the maximum and minimum data values are typically input with values above and below being set equal to the input values (i.e., being clipped). For zero mean blocks, the maximum absolute deviation is typically input, with data that deviates from the mean by more than the input value being clipped. For normalized blocks, no range is required since the range is automatically scaled from −1 to 1. Resolution specifies the minimum difference between points that is observable within a given block. Resolution is typically specified in units of bits per pixel, however, may also equivalently be specified in units relevant to the particular data. The invention is not limited in this regard. Data may be treated either linearly or logarithmically depending on the data type (e.g., density data is typically treated linearly and resistivity data logarithmically). For logarithmic data quantization and filtering procedures are applied to the logarithm of the data. Spatial sampling parameters are typically related to the spatial resolution of the compressed data (e.g., high, medium, or low resolution) and may therefore specify particular block sizes for transmission (e.g., 5×4 pixels as shown on FIG. 5). Alternatively, the spatial sampling parameters may be related to the desired degree of compression of the raw data (e.g., high, medium, or low compression) and may therefore specify the ratio of transmitted pixels to raw data pixels in each direction (e.g., a ratio of 1:4 as in the exemplary embodiment shown on FIGS. 3 and 5). One difficulty that arises in borehole imaging applications is that the data density in the axial direction is not fixed since neither the measured depth nor the rate of penetration are typically known within the downhole tool. One exemplary solution is to assign a time period T for collecting a single trace of data such that the axial density of successive traces is 1/δz at some expected rate of penetration (ROP). Blocks of data of an approximate axial extent Δz (where Δz=ROP/MT=Mδz) may then be compressed and transmitted to the surface. It will be understood that time period T may be advantageously changed during a drilling operation, for example, to accommodate a change in the measured ROP or to change the desired axial density 1/δz of successive traces.

As stated above with respect to FIG. 4, substantially any suitable encoding and telemetry techniques may be utilized to transmit compressed images to the surface, for example, including conventional mud-pulse telemetry encoding and transmission. Such encoding may optionally include conventional error correction encoding, however, the invention is not limited in this regard. It will be understood that in contrast to prior art compression methods, this invention does not require error correction encoding since it is not as susceptible to telemetry errors as is the prior art. Such reduced susceptibility is the result of the compressed image data itself being transmitted to the surface (rather than Fourier coefficients of the image data as in the prior art). Thus, in the present invention, each individual telemetry error is typically isolated to a single pixel. In the prior art a single telemetry error affects a single Fourier coefficient, but it corrupts the entire image (data block) because each pixel depends on all of the transmitted Fourier coefficients in the block. Moreover, the reduced dependency of the present invention on error encoding schemes tends to reduce encoding “overhead” and thereby reduces transmission time, which leads to less data latency.

After a compressed image has been received at the surface it may optionally be resampled at a higher frequency, for example, to smooth the image for display purposes and/or to estimate parameter values at other tool face and time values (i.e., at tool face and time values between the critically sampled values). Such resampling may be accomplished via substantially any known techniques for upsampling band limited data. For example, a Fast Fourier Transform may be taken of the compressed image. The Fourier coefficients may then be padded with one or more zeros and an inverse Fast Fourier Transform applied.

It will be understood that the aspects and features of the present invention may be embodied as logic that may be processed by, for example, a computer, a microprocessor, hardware, firmware, programmable circuitry, or any other processing device well known in the art. Similarly the logic may be embodied on software suitable to be executed by a processor, as is also well known in the art. The invention is not limited in this regard. The software, firmware, and/or processing device may be included, for example, on a downhole assembly in the form of a circuit board, on board a sensor sub, or MWD/LWD sub. Alternatively the processing system may be at the surface and configured to process data sent to the surface by sensor sets via a telemetry or data link system also well known in the art. Electronic information such as logic, software, or measured or processed data may be stored in memory (volatile or non-volatile), or on conventional electronic data storage devices such as are well known in the art.

Although the present invention and its advantages have been described in detail, it should be understood that various changes, substitutions and alternations can be made herein without departing from the spirit and scope of the invention as defined by the appended claims.

I claim:

1. A method for compressing borehole image data, the method comprising:
(a) acquiring image data downhole, the image data including discrete traces associated with corresponding discrete times, each trace including a plurality of borehole parameter values at a corresponding plurality of discrete tool face angles such that the image data includes a two-dimensional array of pixels;
(b) selecting a block of the image data to compress, the block including at least one of the discrete traces;
(c) applying at least one filter to the block;
(d) selecting a subset of pixels from the block, the subset of pixels including at least two of the plurality of discrete tool face angles and at least one of the plurality of discrete times; and
(e) quantizing each of the subset of pixels.

2. The method of claim 1, wherein the image data comprises logging while drilling data.

3. The method of claim 2, wherein the logging while drilling data comprises a member of the group consisting of resistivity data, acoustic impedance data, density data, natural gamma ray data, neutron data, and ultrasonic standoff data.

4. The method of claim 1, wherein the image data comprises a member of the group consisting of:
(i) logging while drilling sensor data segregated into a plurality of bins delineated by tool face and time; and
(ii) logging while drilling sensor data convolved with a predetermined window function.

5. The method of claim 1, wherein (c) further comprises applying a one-dimensional filter in a time domain.

6. The method of claim 1, wherein (c) further comprises:
(i) applying a first one-dimensional filter in a tool face domain; and
(ii) applying a second one-dimensional filter in a time domain.

7. The method of claim 1, wherein the at least one filter comprises a two-dimensional filter.

8. The method of claim 1, wherein the at least one filter is selected from the group consisting of band-pass filters and low-pass filters.

9. The method of claim 1, wherein (c) further comprises computing a sum of the products of a plurality of filter coefficients and a plurality of the borehole parameter values.

10. The method of claim 1, wherein the at least one filter is applied in (c) only to the subset of pixels selected in (d).

11. The method of claim 1, further comprising:
(f) utilizing at least one of the traces to buffer the block in the time domain.

12. The method of claim 1, further comprising:
(f) evaluating the block of image data to identify a tool face value about which the block is most even.

13. The method of claim 1, further comprising:
(f) evaluating the subset of pixels to identify a tool face about which the subset is most even.

14. The method of claim 1, further comprising:
(f) transmitting said quantized pixels to the surface.

15. A method for compressing borehole image data, the method comprising:
(a) acquiring image data downhole, the image data including a two-dimensional array of pixels, each pixel including a borehole parameter value at a corresponding discrete time and a corresponding discrete tool face angle;
(b) applying a filter to selected ones of the array of pixels, thereby generating filtered pixels; and
(c) quantizing the filtered pixels.

16. The method of claim 15, wherein the selected ones of the array of pixels comprise a subset of the array of pixels, the subset including at least two of the discrete tool face angles and at least one of the discrete times.

17. The method of claim 15, wherein the image data comprises logging while drilling data.

18. The method of claim 17, wherein the logging while drilling data comprises a member of the group consisting of resistivity data, acoustic impedance data, density data, natural gamma ray data, neutron data, and ultrasonic standoff data.

19. The method of claim 15, wherein the image data comprises a member of the group consisting of:
(i) logging while drilling sensor data segregated into a plurality of bins delineated by tool face and time; and
(ii) logging while drilling sensor data convolved with a predetermined window function.

20. The method of claim 15, wherein (b) further comprises:
(i) applying a first one-dimensional filter in a tool face domain; and
(ii) applying a second one-dimensional filter in a time domain.

21. The method of claim 15, wherein the at least one filter comprises a two-dimensional filter.

22. The method of claim 15, wherein the at least one filter is selected from the group consisting of band-pass filters and low-pass filters.

23. The method of claim 15, wherein (b) further comprises computing a sum of the products of a plurality of filter coefficients and a plurality of the borehole parameter values.

24. The method of claim 15, further comprising:
(d) telemetering said quantized pixels to the surface.

25. A method for compressing borehole image data, the method comprising:
(a) acquiring image data downhole, the image data including discrete traces at corresponding discrete times, each trace including a plurality of borehole parameter values at a corresponding plurality of discrete tool face angles such that the image data includes a two-dimensional array of pixels;
(b) selecting a block of the image data to compress, the block including a first set of the traces, the first set including at least one trace;
(c) buffering the block in the time domain with a second set of the traces, the second set including at least one trace, the first and second sets including mutually exclusive traces; and
(d) compressing the block.

26. The method of claim 25, wherein (c) further comprises buffering the block in the time domain with a third set of the traces, the third set including at least one trace, the first, second, and third sets including mutually exclusive traces, the second set of traces being acquired before the first set of traces and the third set of traces being acquired after the first set of traces.

27. The method of claim 25, wherein (d) further comprises (i) applying a filter to selected ones of the array of pixels, thereby generating filtered pixels, and (ii) quantizing the filtered pixels.

28. The method of claim 27, wherein:
the filter is a numerical filter;
(c) further comprises buffering the block in the time domain with a third set of the traces, the first, second, and third sets including mutually exclusive traces, the second set of traces being acquired before the first set of traces and the third set of traces being acquired after the first set of traces;
the second and third sets of traces including a number of traces substantially equal to half a length of the numerical filter.

29. A method for compressing borehole image data, the method comprising.
(a) acquiring image data downhole, the image data including discrete traces at corresponding discrete times, each trace including a plurality of borehole parameter values at a corresponding plurality of discrete tool face angles such that the image data includes a two-dimensional array of pixels;
(b) selecting a block of the image data, the block including a plurality of the traces;
(c) processing each of the traces to determine corresponding tool faces at which each of the traces is most even;
(d) processing the corresponding tool faces about which each of the traces is most even to determine a tool face about which the block is most even.

30. The method of claim 29, further comprising:
(e) calculating the even component of the block;
(f) transmitting the even component and the tool face about which the block is most even to the surface.

31. The method of claim 29, further comprising:
(e) calculating a quality factor to evaluate a degree of evenness of the block.

32. The method of claim 29, further comprising:
(e) applying a filter to selected ones of the array of pixels, thereby generating filtered pixels; and
(f) quantizing the filtered pixels.
